(19) United States
(12) Patent Application Publication
(10) Pub. No.: US 2013/0041575 A1
(43) Pub. Date: Feb. 14, 2013

(54) System and Method for Predicting Aircraft Gate Arrival Times

(71) Applicant: James Cole, East Setauket, NY (US)

(72) Inventor: James Cole, East Setauket, NY (US)

(21) Appl. No.: 13/368,947

(22) Filed: Feb. 8, 2012

Related U.S. Application Data
(60) Provisional application No. 61/440,499, filed on Feb. 8, 2011.

(51) Int. Cl. G08G 5/06

(52) U.S. Cl. 701/120

(57) ABSTRACT

A system and method for receiving an estimated ON time for an aircraft, determining an estimated ON to IN time for the aircraft and determining an estimated gate arrival time for the aircraft based on the estimated ON time and the estimated ON to IN time. The system including a calculation engine for performing the steps of the calculation.

### PRIORITY CLAIM/INCORPORATION BY REFERENCE

The present application claims priority to U.S. Provisional Patent Application 61/440,499 filed on Feb. 8, 2011 entitled “System and Method for Predicting Aircraft Gate Arrival Times” naming James Cole as inventor, and hereby incorporates, by reference, the entire subject matter of this Provisional Application.

### BACKGROUND INFORMATION

Estimated aircraft arrival times are normally based on an estimated time when the aircraft's wheels touch down at an airport. This is commonly referred to as the aircraft's “ON” time. However, depending on any number of factors such as the runway on which the aircraft landed, taxi delays, the gate to which the aircraft has been assigned, etc., the actual time the aircraft arrives at its assigned gate may vary significantly from the ON time. The time the aircraft arrives at the gate is commonly referred to as the aircraft's “IN” time. Thus, to provide an accurate estimated time of arrival (“ETA”) for an aircraft it would be helpful to know the estimated ON time and the estimated time from ON to IN.

### SUMMARY OF THE INVENTION

A method for receiving an estimated ON time for an aircraft, determining an estimated ON to IN time for the aircraft and determining an estimated gate arrival time for the aircraft based on the estimated ON time and the estimated ON to IN time.

A system having an input receiving an estimated ON time for an aircraft and a calculation engine determining an estimated ON to IN time for the aircraft and determining an estimated gate arrival time for the aircraft based on the estimated ON time and the estimated ON to IN time.

A system comprising a non-transitory computer readable storage medium storing a set of instructions that are executable by a processor. The instructions being operable to perform the method of receiving an estimated ON time for an aircraft, determining an estimated ON to IN time for the aircraft and determining an estimated gate arrival time for the aircraft based on the estimated ON time and the estimated ON to IN time.

### BRIEF DESCRIPTION OF THE DRAWINGS

FIG. 1 shows an exemplary ETA system 100 according to the exemplary embodiments.

FIG. 2 shows an exemplary method of selecting data grouping for estimation purposes according to an exemplary embodiment.

FIG. 3 shows an exemplary method of estimating the ETA for an aircraft according to an exemplary embodiment.

### DETAILED DESCRIPTION

The exemplary embodiments may be further understood with reference to the following description of the exemplary embodiments and the related appended drawings, wherein like elements are provided with the same reference numerals. The exemplary embodiments are related to systems and methods for predicting aircraft gate arrival times.

As anyone who as ever waited for an arriving passenger at an airport knows, the airline normally displays an estimated time of arrival for arriving flights. However, these estimated times of arrival are generally based on when the aircraft's wheels touch down or the “ON” time. However, just because the aircraft's wheels has touched down, this does not give an accurate time of when the aircraft will actually arrive at the gate allowing the passengers to disembark the aircraft. As described above, the time at which the aircraft arrives at the gate is referred to as the “IN” time. The difference between the ON time and the IN time may be significant and leads to frustration for both the passengers and those awaiting the passengers. A goal of the exemplary embodiments is to provide the airline with a more accurate IN time such that the passengers and those awaiting the passengers have a better estimate of when they will actually be disembarking the aircraft.

In formula form, the ETA of interest for the exemplary embodiments may be expressed as follows:

ETA=Estimated ON time+Estimated ON to IN time

There are various systems that provide the estimated ON times for aircraft and the exemplary embodiments are not concerned with the functionality of those systems. That is, any system that provides the estimated ON time may be used in conjunction with the exemplary embodiments. The exemplary embodiments are directed to systems and methods for estimating the ON to IN time in order to provide an accurate ETA for the aircraft.

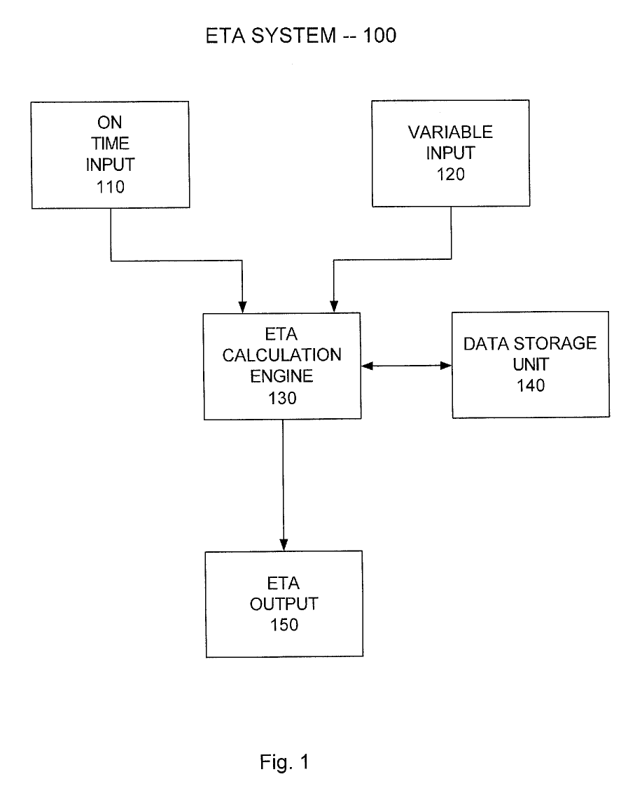

FIG. 1 shows an exemplary ETA system 100 according to the exemplary embodiments. The ETA system 100 includes an ON time input 110 that is an estimate of the aircraft's ON time. As described above, the ON time input 110 may be from any known system that provides this type of data. A second input to the ETA system 100 is a variable input 120 that is any number of variables for both the aircraft and/or the airport that may be used to calculate or determine an aircraft's ON to IN time. Exemplary variables that may be used to calculate the ON to IN times are provided below. It is noted that while the variable input 120 is shown as a single input, the variables that are used to calculate the ON to IN times may, in fact, come from a variety of sources, such as active radar sources, passive radar sources, ground surveillance radar, FAA sources, etc. Thus, it should be understood that the variable input 120 may include any number of sources.

The ETA system 100 also includes an ETA calculation engine 130 and a data storage unit 140. The calculations performed by the ETA calculation engine 130 will be described in greater detail below, but, in general, the data from inputs 110 and 120 either alone, or in combination, with data that is stored in the data storage unit 140 is used to calculate the ETA in accordance with the formula described above. The ETA calculation engine 130 will provide the results of the ETA calculations to an ETA output device 150 for use by the user. The ETA output device 150 may be, for example, a display device, a printer, etc., or may simply be an output to another related system that then provides a display of the ETA.

The data storage unit 140 stores the data that is input from the data inputs 110 and 120 and also stores historical data such as previous ETA calculations and/or actual operating experience such as when a particular flight arrived at the gate. The data storage unit 140 may be, for example, a non-transitory storage medium that both stores the data described above and stores lines of code that may be executed by a processor to perform some or all of the functionalities described herein for the ETA system 100. For example, the data storage unit 140 may be a memory device provided in a personal computer or server computer that may perform the tasks of the ETA system 100. However, the data storage unit 140 may also be a data storage device that is remote from such computing devices. It is also noted that the manner of storing the data may be in any known way, such as, a database, a table, an array, etc.

In one exemplary embodiment, the ETA calculation engine 130 may be embodied as a processor executing lines of code that operates to perform the calculations described herein. For example, the ETA system 100 may be embodied on a personal computer having a memory storing the data that is input via inputs 110 and 120 and instructions for performing the calculations of the calculation engine 130, a processor for executing the instructions stored in the memory and a display device to receive the results of the calculations from the processor to display to a user. The processor may be, for example, one of the Intel families of processors (e.g., Pentium, Xeon, Celeron, Itanium, etc.), commonly used in PCs and Apple Mac computers.

Moreover, the use of a personal computer is also only exemplary. For example, the system 100 may be embodied on a server computer (or multiple networked devices) to which users have network or Internet access. Thus, a user may remotely access the ETA system 100 to perform the ETA calculations and/or view the results of the ETA calculations.

In an exemplary embodiment, different variables that may be input from variable input 120 and may be considered when estimating the ON to IN times, include, for example:

1. airport;

2. day of week;

3. time of day (e.g., quantized to 15 minute intervals);

4. arrival runway end (two per runway);

5. gate assignment.

Those of skill in the art will understand that other variables may also be used and the above variables are only exemplary.

For example, if the above variables were considered and it were further considered that the airport under consideration had six (6) runways and one hundred (100) gates, this could possibly yield 806,400 data points for the variables in a single week (e.g., 7 days*24 hours/day*4 intervals/hour*6 runways*2 ends/runway*100 gates=806,400 data points). That is, the actual ON to IN times for all the aircraft associated with these data points may be collected and used for estimation purposes.

This data may be stored by data storage unit 140, for example, in a look-up table or any other structure suitable for storing data and then may be used by the ETA calculation engine 130 to estimate the ON to IN time for any particular aircraft. Those skilled in the art will understand that there are numerous manners of using the data to estimate the ON to IN time for an aircraft. In a first example, an exact match of data may be searched. For example, an aircraft may be landing on the south end of runway 1L on Tuesday at 3:07 pm and is assigned gate 78. The ETA system 100 may search for these exact variables to determine if any previous aircraft matched these variables. If a match is found, the actual ON to IN time for this match may be used to estimate the ON to IN time for the current flight and therefore the ETA for the current flight.

While exact matching may be used, it may not always be the most accurate manner of estimating the ON to IN times because there may be only one or very few exact matches. The statistical significance of one or a few data points may be quite low and therefore, may result in a wide variance in times. This wide variance may not produce the most accurate estimates of ON to IN times. Thus, other methods of using the data for estimation purposes may be used. For example, airport averaging of all the data values may be used. In other examples, averages based on any one of the variables may be used, e.g., time of day, runway, gate assignment, etc.

In a further example, values of independent variables may be grouped. The groupings may be determined by comparing models against measured values of ON to IN times. For example, once a statistically significant amount of data is collected for a particular airport, the variables may be grouped to determine if the ON to IN time estimate is accurate. To provide a specific example, it may be hypothesized that the most important variables are runway ends and gate assignments. Thus, data for runway ends and adjacent gates may be grouped to determine an average ON to IN time for such a grouping. This average ON to IN time may then be used to make an estimate for an incoming aircraft. The system itself or an operator may then determine the variance between the estimated ON to IN time and the actual ON to IN time for the aircraft. If the estimate is within an acceptable error band, this may confirm that the grouping is the correct grouping. If the estimate is not within an acceptable error band, then additional variables may be included in the current grouping or a completely different set of variables and grouping may be used in order to come up with a more accurate grouping.

Those skilled in the art will understand that the grouping described above is only exemplary and that other groupings may be used. The grouping may be, as described in the above example, the grouping of values from one or more independent variables while ignoring values from other independent variables or including all variables. The grouping that is ultimately used for estimation purposes may be determined by minimizing the variance of the measured ON to IN times for each group averaged over all groups. The minimization of average variance tends to increase grouping by reducing statistical uncertainty, but reducing inappropriate grouping. In one example, the best predicted value for each group may be determined by minimizing the root mean square deviation between the grouped measurements and the predicted value.

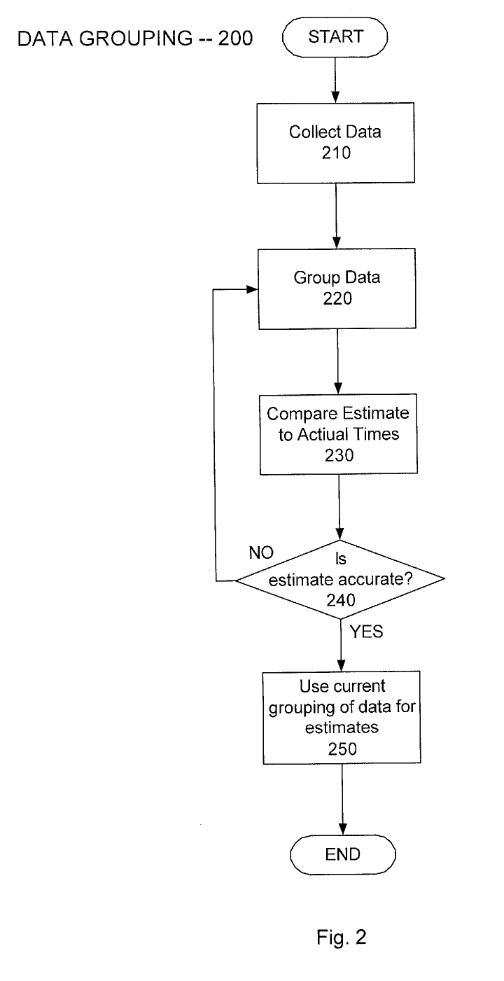

FIG. 2 shows an exemplary method 200 of selecting the data grouping for estimation purposes. In step 210, the data is collected (e.g., day of week, time of day, arrival runway end, gate assignment, etc. and actual ON to IN times). This data is collected via, for example, the sources associated with variable input 120 and stored in data storage unit 140.

In step 220, the data is grouped as described above by the ETA calculation engine 130. In step 230, the estimates of the ON to IN times based on the data groupings are compared to the actual ON to IN times. That is, the ETA calculation engine 130 compares previous estimations of the ON to IN times for various flights to the actual ON to IN times for those flights based on the data stored in the data storage unit 140.

In step 240, it is determined whether the estimates based on the groupings are accurate for the purposes of using the data groupings for further estimates. The determination of accuracy may be based on any known type of statistical accuracy determination. For example, is the estimate accurate to within a threshold (e.g., 3 minutes), 95% of the time. If the estimates are not accurate based on the decided statistical measurement of accuracy, the process steps back to step 220 to re-group the data into additional groupings of the data so that a more accurate estimate may be formed. As described above, the best grouping may be determined by the minimization of the variance for each group averaged over all groups. Thus, determining whether the estimation is correct in step 240 may involve such minimization. Those skilled in the art will understand that the minimization may also involve the actions associated with steps 220 and 230.

If the estimation is correct (e.g., the variance of the measured ON to IN times compared to the estimates is minimized), the method may proceed to step 250 where the current groupings may be used to determine the estimates for the ON to IN times. Thus, at the completion of the method 200, the ETA system 100 will have the data groupings that have the highest likelihood of producing the best ETA estimate. It should be noted that the data groupings that are best for one airport may not be the best for another airport because there may be physical and/or operations differences between the airports. Thus, the data grouping may be performed for the data at each individual installation of the ETA system 100. Furthermore, the data grouping method 200 may also be performed periodically at an individual airport because the best groupings may change over time, again, based on new physical configurations, operating procedures or even times of the year.

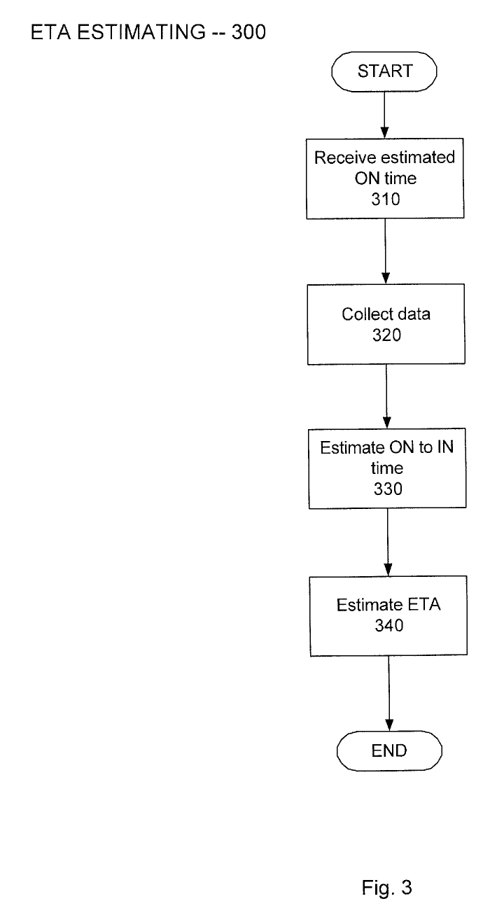

FIG. 3 shows an exemplary method 300 of estimating the ETA for an aircraft. In step 310, the ETA system 100 receives an estimate of the aircraft's ON time that will be used for the ETA, e.g., from the ON time input 110. In step 320, the ETA system 100 receives data or variables concerning the aircraft such as the runway end it will land at, the gate it has been assigned, etc., e.g., via variable input 120. Those skilled in the art will understand that the data received in steps 310 and 320 are not required to be received in that order. It is possible that the estimated ON time may be received simultaneously with or later than the data received in step 320. In addition, the data received in steps 310 and 320 may be constantly updated (e.g., as the ON time estimate is revised, gate changes, runway configuration changes, etc.), so the ETA may be constantly updated.

In step 330, the ON to IN time for the aircraft will be estimated based on the data received in step 320 and the groupings of data determined, for example, with reference to the method 200 described with reference to FIG. 2. Once the ON to IN time has been estimated, this time may be added to the received ON time to provide the ETA for the aircraft in step 340. As described above, the ETA may then be output to the ETA output 150 for display to users.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Mac platform and MAC OS, etc. In a further example, the exemplary embodiments of the calculation engine may be a program containing lines of code stored on a non-transitory computer readable storage medium that, when compiled, may be executed on a processor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

What is claimed is:

1. A method, comprising:
receiving an estimated ON time for an aircraft;
determining an estimated ON to IN time for the aircraft; and
determining an estimated gate arrival time for the aircraft based on the estimated ON time and the estimated ON to IN time.

2. The method of claim 1, wherein the estimated ON to IN time is determined based on at least one of an identification of an airport, a day of a week, a time of the day, an arrival runway end and a gate assignment.

3. The method of claim 1, wherein determining the estimated ON to IN time includes:
matching variables for the aircraft to previously stored data for similar variables.

4. The method of claim 3, wherein the matching of variables is based on an average of the stored data for the similar variables.

5. The method of claim 3, wherein the matching of variables includes:
grouping the variables according to an order of importance.

6. The method of claim 5, wherein the estimated ON to IN time is based on minimizing a root mean square deviation between grouped variables and a predicted value.

7. A system, comprising:
an input receiving an estimated ON time for an aircraft; and
a calculation engine determining an estimated ON to IN time for the aircraft and determining an estimated gate arrival time for the aircraft based on the estimated ON time and the estimated ON to IN time.

8. The system of claim 7, further comprising:
a data storage unit storing the estimated ON time, the estimated ON to IN time and the estimated gate arrival time for the aircraft.

9. The system of claim 7, wherein the estimated ON to IN time is determined by the calculation engine based on at least one of an identification of an airport, a day of a week, a time of the day, an arrival runway end and a gate assignment.

10. The system of claim 8, wherein the calculation engine determines the estimated ON to IN time by matching variables for the aircraft to data for similar variables previously stored in the data storage unit.

11. The system of claim 10, wherein the calculation engine matches the variables based on an average of the stored data for the similar variables.

12. The system of claim 10, wherein the calculation engine matches the variables by grouping the variables according to an order of importance.

13. The system of claim 12, wherein the calculation engine estimates ON to IN time based on minimizing a root mean square deviation between grouped variables and a predicted value.

14. A system comprising a non-transitory computer readable storage medium storing a set of instructions that are executable by a processor, the instructions being operable to perform the method of:
receiving an estimated ON time for an aircraft;
determining an estimated ON to IN time for the aircraft; and
determining an estimated gate arrival time for the aircraft based on the estimated ON time and the estimated ON to IN time.

15. The system of claim 14, wherein the estimated ON to IN time is determined based on at least one of an identification of an airport, a day of a week, a time of the day, an arrival runway end and a gate assignment.

16. The system of claim 14, wherein the set of instructions further perform the method of:
matching variables for the aircraft to previously stored data for similar variables.

17. The system of claim 16, wherein the matching of variables is based on an average of the stored data for the similar variables.

18. The system of claim 18, wherein the set of instructions further perform the method of:
grouping the variables according to an order of importance.

19. The system of claim 18, wherein the estimated ON to IN time is based on minimizing a root mean square deviation between grouped variables and a predicted value.
